(19) United States
(12) Patent Application Publication
(10) Pub. No.: US 2025/0340149 A1
(43) Pub. Date: Nov. 6, 2025

(54) SYSTEMS AND METHODS FOR LOAD MANAGEMENT ACROSS MULIPLE CHARGERS

(71) Applicant: Caterpillar Inc., Peoria, IL (US)

(72) Inventors: James Chase, Chillicothe, IL (US); Malshantha Mawella Kankanamge, Marana, AZ (US); Kea Voa Chin, Washington, IL (US); Gabe Coto, Peoria, IL (US)

(73) Assignee: Caterpillar Inc., Peoria, IL (US)

(21) Appl. No.: 18/654,207

(22) Filed: May 3, 2024

(51) Int. Cl. B60L 53/67; B60L 53/30; B60L 53/62; B60L 53/66

(52) U.S. Cl. CPC B60L 53/67; B60L 53/62; B60L 53/66; B60L 53/305

(57) ABSTRACT

Systems and methods for load management across multiple chargers are disclosed herein. The method can include receiving, by a charge dispenser, a charge request from an electric machine, the charge request including a power demand. The method can include receiving, by the charge dispenser, from a plurality of charging modules, one or more metrics corresponding to a charging module of the plurality of charging modules. The method can include selecting, by the charge dispenser, a subset of the plurality of charging modules to satisfy the power demand, according to the one or more metrics. The method can include supplying, by the charge dispenser, power from the subset of charging modules to the electric machine, according to the power demand.

### TECHNICAL FIELD

The present implementations relate generally to managing loads across multiple chargers associated with a charge dispenser.

### BACKGROUND

The present disclosure relates generally to the management of multiple chargers which may be across different applications and worksites. Chargers may be used to provide power to one or more machines used at the worksite. The load placed on the multiple chargers may cause the chargers to deteriorate, due to wear and tear or to have different operating behaviors or efficiencies.

For example, U.S. Publication No. 2011/0304298A1 describes systems and methods providing improved battery charging using systems comprising multiple chargers. The chargers can communicate with each other. A battery management unit (BMU) can be used to communicate with at least one of the chargers, and, in some cases, all of the chargers. The system can be configured such that the charging load can be distributed among multiple chargers, or to a single charger, depending on the amount of charging power required at a given time. The system can also be configured to alternate which charger(s) handle the charging load over a period of time. For example, when only a single charger is needed to handle the total charging load, the system can be configured such that the load is handled by a first charger over a first period of time, a second charger of a second period of time, etc. The charging load distribution scheme can be based at least in part upon one or more commands transmitted between two chargers and/or between a charger and the BMU.

### SUMMARY

A first aspect provided herein relate to a method. The method can include receiving, by a charge dispenser, a charge request from an electric machine, the charge request including a power demand. The method can include receiving, by the charge dispenser, from a plurality of charging modules, one or more metrics corresponding to a charging module of the plurality of charging modules. The method can include selecting, by the charge dispenser, a subset of the plurality of charging modules to satisfy the power demand, according to the one or more metrics. The method can include supplying, by the charge dispenser, power from the subset of charging modules to the electric machine, according to the power demand.

A second aspect provided herein relate to a charge dispenser. The charge dispenser can include a charge connector configured to interface with one or more electric machines. The charge dispenser can include a communication interface communicably coupled to a plurality of charging modules. The charge dispenser can include a processing circuit comprising one or more processors and memory storing instructions that, when executed, cause the processing circuit to: receive a charge request from an electric machine which is interfacing with the charge connector, the charge request including a power demand. The charge dispenser can receive, via the communication interface from the plurality of charging modules, one or more metrics corresponding to a charging module of the plurality of charging modules. The dispenser can select a subset of the plurality of charging modules to satisfy the power demand, according to the one or more metrics, and supply, via the charge connector, power from the subset of charging modules to the electric machine, according to the power demand.

In a third aspect, this disclosure is directed to a system. The system includes a plurality of charging modules configured to receive power from a power source and supply output power. The system includes a charge dispenser. The charge dispenser includes a charge connector configured to interface with one or more electric machines, a communication interface communicably coupled to the plurality of charging modules, and a processing circuit. The processing circuit includes one or more processors and memory storing instructions that, when executed, cause the processing circuit to receive a charge request from an electric machine which is interfacing with the charge connector, the charge request including a power demand. The processing unit can also receive, via the communication interface, from the plurality of charging modules, one or more metrics corresponding to a charging module of the plurality of charging modules, select a subset of the plurality of charging modules to satisfy the power demand, according to the one or more metrics, and supply, via the charge connector, power from the subset of charging modules to the electric machine, according to the power demand.

### BRIEF DESCRIPTION OF THE DRAWINGS

These and other aspects and features of the present implementations will become apparent to those ordinarily skilled in the art upon review of the following description of specific implementations in conjunction with the accompanying figures.

FIG. 1 depicts an example system to manage the load across multiple charging modules, in accordance with present implementations.

FIG. 2 depicts an example power distribution site, in accordance with present implementations.

FIG. 3 depicts an example an example charge dispenser, in accordance with present implementations.

FIG. 4 is a flowchart showing a first example method to manage the load across multiple charging modules, in accordance with present implementations.

FIG. 5 is a flowchart showing a second example method to manage the load across multiple charging modules, in accordance with present implementations.

### DETAILED DESCRIPTION

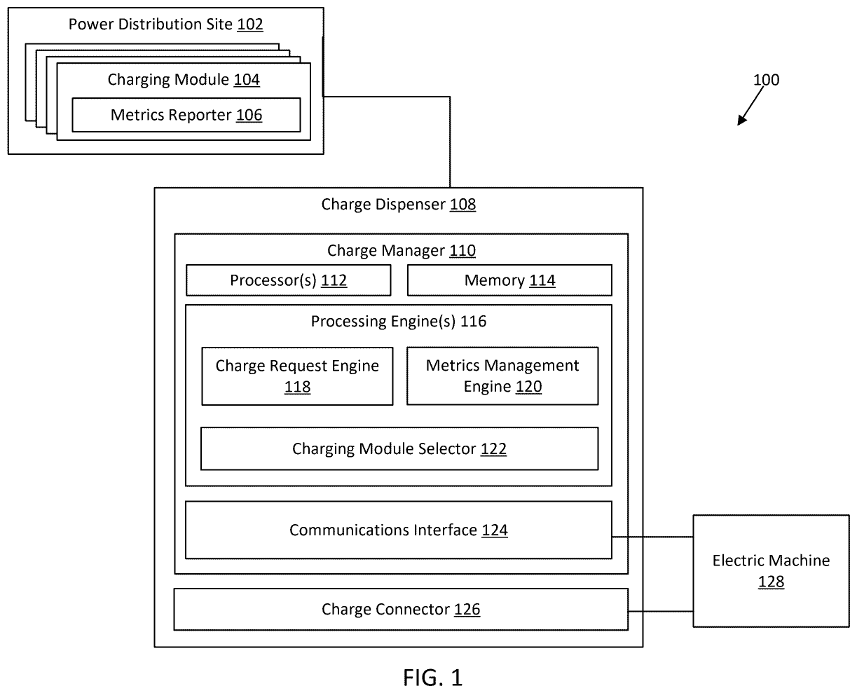

FIG. 1 depicts an example system 100 to manage the load across multiple charging modules. The system 100 can include a power distribution site 102, a charge dispenser 108, and an electric machine 128. The power distribution site 102 may be configured to charge (e.g., provide power) to the electric machine 128 via the charge dispenser 108. In some embodiments, the power distribution site 102 includes charging modules 104. The charging modules 104 can be connected to one or more power sources, such as electrical outlets, generators, or power supply units, among others. The charging modules 104 can be or include respective battery banks or energy storage devices. The charging modules 104 can store energy for provision (e.g., as electrical energy) to heavy electric machinery, worksite components, and/or other machines such as the electric machine 128, for charging and/or recharging such devices or machines. For example, an electric machine 128 (such as an electrically powered/driven heavy machinery or vehicle) can connect to the charging modules 104, via the charge dispenser 108, to recharge batteries of the electric machine 128.

In some embodiments, the charging modules 104 include a metrics reporter 106. The metrics reporter 106 may be configured to measure one or more metrics associated with the charging modules 104 and provide the metrics to the charge dispenser 108. The metrics reporter 106 may be configured to detect, quantify, sense, or otherwise measure the metrics associated with its respective charging module 104 using one or more sensors. In some embodiments, the metrics determined by the metrics reporter 106 and provided to the charge dispenser 108 may include usage hours, a charge current capability, a charge power capability, a discharge current capability, a discharge power capability, an actual current, an actual power, a contactor status, and/or a charger voltage. In some embodiments, the metrics reporter 106 may be configured to provide the metrics to the charge dispenser 108 periodically (e.g., every N time instances), on demand based on a request from the charge dispenser 108 (e.g., when the charge dispenser 108 receives a request to charge, periodically while the charge dispenser 108 is supplying power to an electric machine 128 to charge the electric machine 128, and so forth).

In some embodiments, the metrics reporter 106 may be configured to communicate, send, transmit, or otherwise provide a status of the respective charging module 104. The metrics reporter 106 may be configured to determine the status of the charging module 104 based on the metric(s) identified/sensed for the charging module 106. For example, the metrics reporter 106 may be configured to determine the status, based on a comparison of one or more of the metrics to a corresponding threshold/criterion, to identify the corresponding status. As one example, where the charger voltage is less than a threshold voltage, the metrics reporter 106 may be configured to determine the status of the charging module 104 as a reduced status (or a second status). On the other hand, where the charger voltage is greater than/equal to/satisfy the threshold voltage, the metrics reporter 106 may be configured to determine the status of the charging module 106 as a full status (or first status). While these determinations are described with reference to the metrics reporter 106, it is noted that, in some embodiments, the charge dispenser 108 (e.g., the metrics management engine 120) may be configured to determine the charging module status based on or according to the metrics from the respective metrics reporter 106 and/or based on the metrics from the respective metrics reporter 106 as compared to metrics corresponding to another charging module 104.

The charge dispenser 108 can manage and balance the load across the charging modules 104 based on the metrics provided by the metric reporter 106. The charge dispenser 108 may be configured to receive data (e.g., metrics from the metrics reporter, etc.) from the power distribution site 102 and determine how to balance the load of charging the electric machine 128 based on the data. Particularly, the charge dispenser 108 includes a charge manager 110 which is configured to manage and balance the load across the multiple charging modules 104. The charge dispenser 108 also includes a charge connector 126 which may physically couple with the electric machine 128 to provide charge to the electric machine 128.

The charge manager 110 includes processor(s) 112, a memory 114, and processing engine(s) 116. The processor(s) 112 may be or include any device, component, element, or hardware designed or configured to perform the various steps recited herein. For example, the processor(s) 112 may include any number of general purpose single-or multi-chip processors, digital signal processors (DSP), application specific integrated circuits (ASIC), field programmable gate arrays (FPGA), or other programmable logic device(s), discrete gate or transistor logic, discrete hardware components, or any combination thereof designed or configured to perform the various steps recited herein. In some embodiments, the charge manager 110 may include a single processor 112 designed or configured to perform each of the various steps recited herein.

In some embodiments, the charge manager 110 may include multiple processors 112 which are designed or configured perform (e.g., either separately or together) each of the various steps recited herein. As one example, the charge manager 110 may include a first processor 112 designed or configured to perform a first subset of the various steps, and a second processor 112 designed or configured to perform a second subset of the various steps (with the first subset being different from the second subset). As another example, the charge manager 110 may include first and second processors 112 which together perform the various steps in a distributed fashion. As such, unless explicitly indicated otherwise, such as by use of a term such as “a single processor”, the term “one or more processor(s)” as used herein contemplates and encompasses embodiments in which all of the one or more processors perform all of the recited steps or features, different processors separately perform different ones of the steps or features, the same or different sets of two or more processors work in combination to perform individual steps or features, or any variation thereof. In other words, unless explicitly indicated otherwise, the use of the term “one or more processors” herein contemplates and encompasses a single processor performing all of the recites steps or features and two or more processors working individually or in combination, where each step or feature is performed by any one or combination of two or more of the processors.

The memory 114 can store data associated with the charge dispenser 108. The memory 114 can include one or more hardware memory devices to store binary data, digital data, or the like. The memory 114 can include one or more electrical components, electronic components, programmable electronic components, reprogrammable electronic components, integrated circuits, semiconductor devices, flip flops, arithmetic units, or the like. The memory 114 can include at least one of a non-volatile memory device, a solid-state memory device, a flash memory device, and a NAND memory device. The memory 114 can include one or more addressable memory regions disposed on one or more physical memory arrays. A physical memory array can include a NAND gate array disposed on, for example, at least one of a particular semiconductor device, integrated circuit device, or printed circuit board device.

The processing engine 116 includes a charge request engine 118, a metrics management engine 120, and a charging module selector 122. The charge request engine 118 may be configured to receive a charge request from an electric machine 128, when the electric machine 128 connects to the charge dispenser 108 (e.g., via the charge connector 126). In some embodiments, the charge request engine 118 may be configured to verify or authenticate that the electric machine 128 has the necessary permissions to connect to the charge dispenser and receive power from the power distribution site 102 (for example, based on data received from the electric machine 128 via a serial bus, ethernet connector, or other communications channel via the charge connector 126 and/or communication interface 124). Once the charge request engine 118 has verified the charge request from the electric machine 128, the charge request engine 118 may send a command that the electric machine 128 can be charged by the charge dispenser 108.

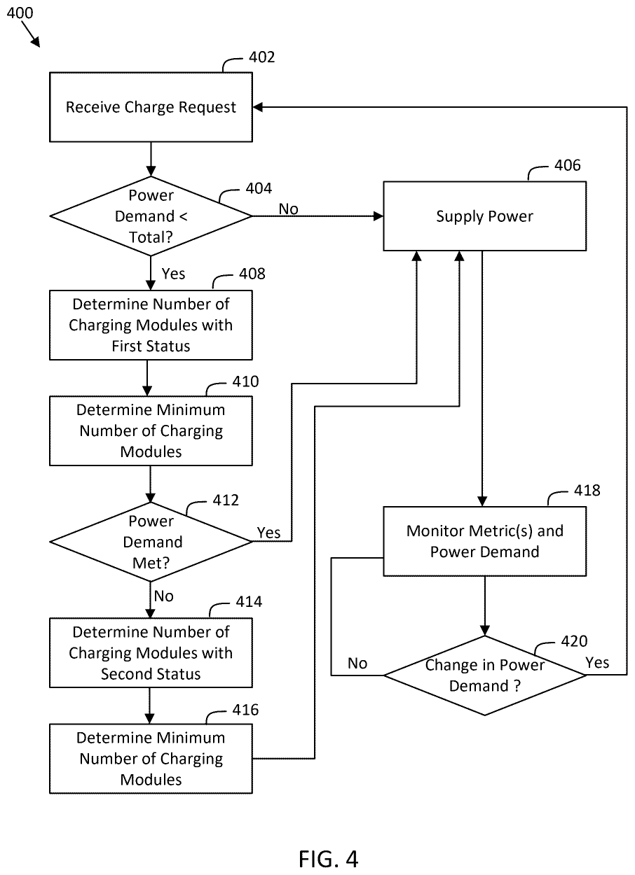

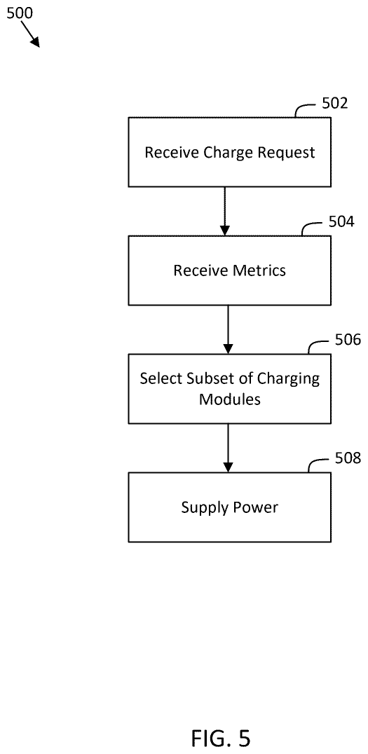

The metrics management engine 120 may be configured to receive the metrics from the metrics reporter 106. In some embodiments, the metrics management engine 120 may convert the metrics to a standardized format. The metrics management engine 120 may provide the metrics to the charging module selector 122 which is configured to select which of the charging modules 104 are to provide power for charging to the electric machine 128. The metrics management engine 120 may make this selection based on execution of the methods shown in FIGS. 4 and 5 which are described in more detail below.

The charge dispenser 108 further includes the communications interface 124. In some embodiments, the communications interface 124 facilitates the charge dispenser being communicably connected to other components in the system 100 (e.g., power distribution site 102 and electric machine 128) to transmit and receive data from these components. In some embodiments, the communications interface 124 is a wireless interface that utilizes wireless protocols, such as Wi-Fi, cellular (e.g., LTE, 4G, etc.), Bluetooth, near-field communication (NFC), radio frequency identification (RFID), Zigbee, etc. In other embodiments, the communications interface 124 includes a wired interface, such as a serial communication interface that uses protocols such as a serial peripheral interface (SPI) bus, universal serial bus (USB), controller area network (CAN) bus, and so on.

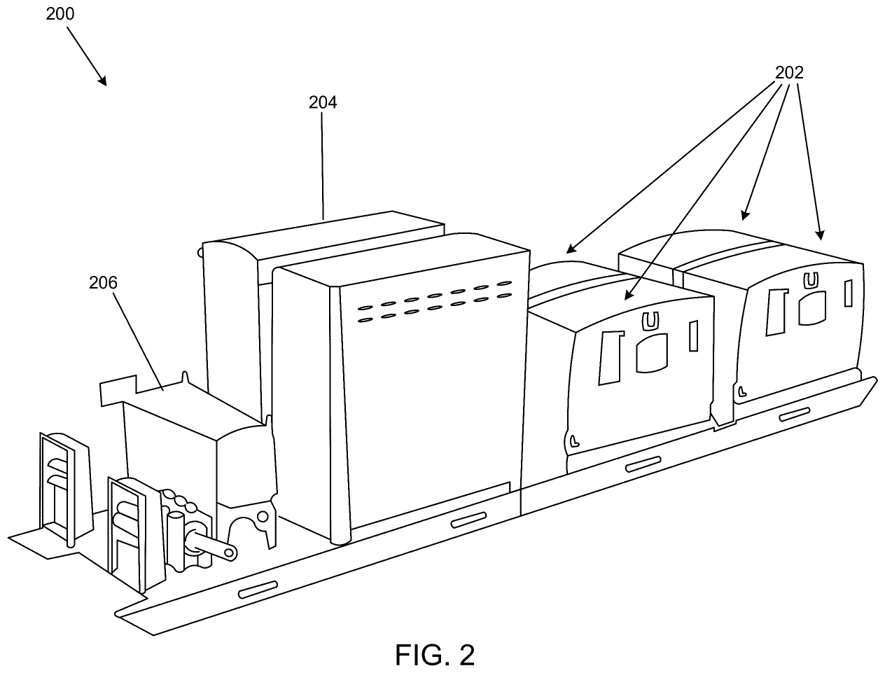

FIG. 2 depicts an example power distribution site 200, in accordance with present implementations. The power distribution site 200 is similar to the power distribution site 102 described above. For example, the power distribution site 200 includes charging modules 202 similar to charging modules 104 described above. Further, the distribution site 200 includes transformers 204 and interfaces 206. The transformer 204 may be a power control device that is used in the distribution and transmission of alternating current power. The transformer 204 may be configured to either step-up or step-down the voltage used by the charging modules 202. In some embodiments, the interfaces 206 may be circuit breakers or switching devices configured to control the connection of devices within the power distribution site 200.

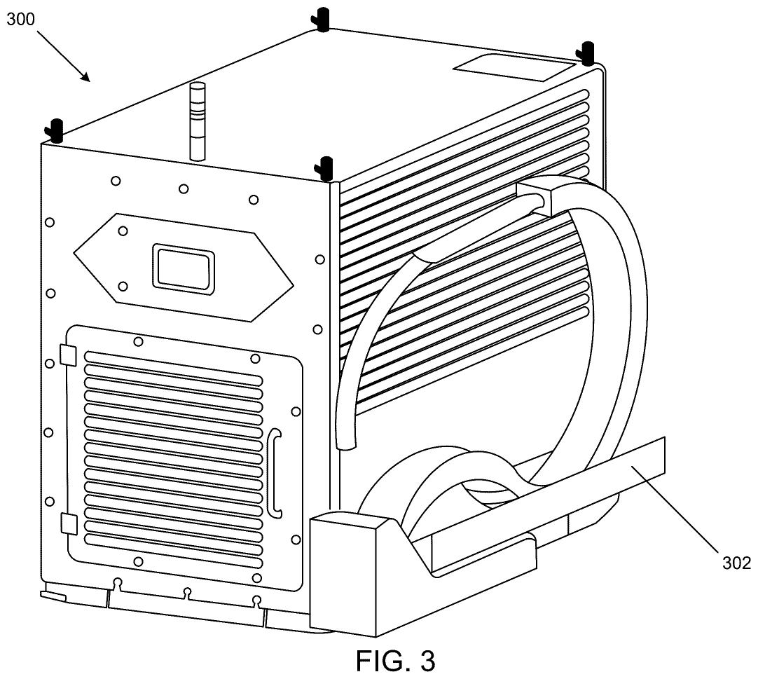

Referring now to FIG. 3, a three-dimensional rendering of a charge dispenser 300 is shown according to an example embodiment. The charge dispenser 300 is similar to charge dispenser 108 described above with the respect to FIG. 1. The charge dispenser 300 include a charge connector 302 which is similar to the charge connector 126 described above. The charge dispenser 300 may be electrically connectable or couplable to the power distribution site 200. For example, the charge dispenser 300 may include a connector (not shown) which is configured to establish an electrical connection with the interfaces on 202, to receive power from the power distribution site 200. The charge dispenser 300 may house the charge manager 110 and communications interface 124 described above with reference to FIG. 1. In this regard, the charge dispenser 300 may be configured to generate and send control signals to the power distribution site 200, to control which charging module(s) 202 supply power stored thereby to the charge dispenser 300 for providing to the electric machine 128 (via the charge connector 302).

### Industrial Applicability

The disclosed embodiments may be applicable to any charging system or solution, where electrical machines are charged. For example, the disclosed embodiments may be applicable or applied to an electrical vehicle charging station. The disclosed embodiments may also be applicable to a variety of worksites, such as an excavation site, a mining site, a demolition site, or any other type of industrial worksite, charging locations, charging sites, electrical power grid. Similarly, the charging system described herein may be used to provide power to various power sources or loads, including but not limited to a machine, such as a bulldozer, a forklift, or any other type of machinery, a generator, a transformer, or any other type of electrical component which requires charging or electrical power.

FIG. 4 depicts first method 400 for managing a load requested from one or more electric machines requesting charge across multiple charging modules. The method 400 can be performed by, using, or for system 100. For example, the method 400 may be executed by the charge manager 110 of FIG. 1.

At step 402, the method 400 can include receiving a charge request. The charge request may be received from one or more electric machines coupled to (e.g., via the charge connector 126/302) and configured to receive power from the charge dispenser 108. In some embodiments, the charge request includes a power demand which indicates the power requested to charge the electric machine 128. In some embodiments, the power demand consists of voltage and current limits required to charge the machine.

At step 404, the method 400 can include determining if the power demand received at step 402 is less than the total power capacity of the power distribution site. If the power demand is not less than the total power capacity of the power distribution site, the method proceeds to step 406. In other words, the process for balancing the load across multiple charging modules may be implemented when the power demand is less than the total capacity. Otherwise, the total capacity of the charging modules may be provided to satisfy as much of the power demand as possible. At step 406, the charge manager 110 can generate a command for transmission to the charging modules 104 at the power distribution site 102, to supply power at full capacity to satisfy the power demand. If the power demand is less than the total power capacity of the power distribution site, the method proceeds to step 408.

At step 408, the method 400 can include determining a number of charging modules 104 with a first status. In some embodiments, the first status may indicate that the charging modules 104 are considered healthy. As described above, the metrics reporter 106 and/or metrics management engine 120 may determine the status of the charging modules 104, based on one or more metrics associated with the charging modules 104 (e.g., received from the metrics reporter 106 of the respective charging modules 104). For example, the metrics management engine 120 may compare the metrics to one or more thresholds (and/or to metrics of other charging modules 104), to determine the status of the charging modules 104. The metrics management engine 120 may determine the status of each of the plurality of charging modules 104, based on the corresponding metrics.

At step 410, the method 400 can include determining a minimum number of charging modules with the first status which can provide the power to meet the power demand received with the charge request. For example, a power distribution site may include four charging modules. In this example, two of the charging modules may have a first status (e.g., full/healthy) while the other two charging modules may have a second status (e.g., reduced/unhealthy). In such a case, the charge manager 110 may determine a minimum number of the two charging modules with the first status which can provide enough power to meet the power demand. In some cases, the minimum number of charging modules may be less than the total number of charging modules with the first status (e.g., one charging module of the two charging modules with the first status can provide enough power to meet the power demand). In other cases, the minimum number of charging modules may be equal to (or greater than) the total number of charging modules with the first status (e.g., both of the charging modules with the first status are needed to provide enough power to meet the power demand).

At step 412, the method can include determining whether the power demand received with the charge request at step 402 can be met by the minimum number of charging modules with the first status as determined at step 410. If the power demand can be met with the minimum number of charging modules with the first status, the method proceeds to step 406, where the power is supplied to the electric machine 128 with power from the minimum number of charging modules having the first status. If the power demand cannot be met with the minimum number of charging modules with the first status, the method proceeds to step 414.

At step 414, the method 400 can include determining a number of charging modules 104 with a second status. In some embodiments, the second status may indicate that the charging modules 104 are considered unhealthy. Similar to step 408, the metrics reporter 106 and/or metrics management engine 120 may determine the status of the charging modules 104, based on one or more metrics associated with the charging modules 104 (e.g., received from the metrics reporter 106 of the respective charging modules 104). Additionally, in some embodiments, the metrics reporter 106 and/or metrics management engine 120 may determine or assign the second status to the charging modules 104, based on manual input from a user (such a technician or operator of the charge dispenser 108). Additionally, in some embodiments, the metrics reporter 106 and/or metrics management engine 120 may determine or assign the second status to the charging modules 104 based on one or more fault codes activated within the charging modules. Further, in some embodiments, the metrics reporter 106 and/or metrics management engine 120 may determine or assign the second status to the charging modules 104 based on the usage time of the charging modules 104 (e.g., to assign the a charging module 104 the second status based on having the greatest usage time as compared to other charging module(s) 104). In this example, the charge dispenser 108 may prioritize using charging modules 104 which have been used less, and/or have not been used as much recently, as compared to other charging modules 104.

At step 416, the method 400 can include determining a minimum number of charging modules with the second status which can provide the power necessary to meet the power demand received with the charge request. Continuing the above example in which a power distribution site has four charging modules, two of which have the first status and the other two of which have the second status, the charge manager 110 may supplement the power provided by the two charging modules with the first status, with power provided by a minimum number of charging modules with the second status. In some cases, the minimum number of charging modules may be less than the total number of charging modules with the second status (e.g., one charging module of the two charging modules with the second status can provide enough power to meet the power demand). In other cases, the minimum number of charging modules may be equal to the total number of charging modules with the second status (e.g., both of the charging modules with the second status are needed to provide enough power to meet the power demand). At step 406, the power is supplied to the electric machine with power from the minimum number of charging modules with the first status determined at step 410 and the minimum number of charging modules with the second status determined at step 416.

After the power has been supplied at step 406, the charge manager 110 can continue to monitor the metrics and power demand from the electric machine at 418. If there is a change in the power demand at step 420, and/or a change in a status of one of the charging modules (e.g., from the first to the second status or vice versa, the method may be repeated/re-executed starting at step 402, according to the change in the power demand and/or change in statuses.

FIG. 5 depicts a second method 500 for managing a load received from one or more electric machines requesting charge across multiple charging modules. The method 500 can be performed by, using, or for system 100. For example, the method 500 may be executed by the charge manager 110 of FIG. 1.

At step 502, the method 500 can include receiving a charge request. The charge request may be received from one or more electric machines coupled to and configured to receive power from the charge dispenser 108. In some embodiments, the charge request includes a power demand which indicates the power requested to charge the electric machine 128.

At step 504, the method 500 can include receiving metrics associated with the charging modules 104. In some embodiments, these metrics may include a charge current capability, a charge power capability, a discharge current capability, a discharge power capability, an actual current, an actual power, a contactor status, and a charger voltage, amongst others. As described above, the charge manager 110 may receive metrics from the metrics reporter 106. The metrics for each of the charging modules may be used to determine a status of the charging modules (e.g., healthy, unhealthy, etc.).

At step 506, the method 500 includes selecting a subset of charging modules 104 which may used to supply power to the electric machine 128. The process for selecting the charging module to supply the power to electric machine is described in more detail above with respect to steps 408-420 of method 400. At step 508, the power is supplied to the electric machine with power from the selected subset of charging modules.

The disclosed charge manager 110 may be provided to increase the longevity of power distribution sites by utilizing a charge manager which distributes the load placed on chargers at the charging site across one or more subsets of charging modules. For example, because the charge manager 110 receives metrics from the charge modules and determines a health status of the charging modules based on the metrics, the charge manager 110 can better load balance the charging modules for providing power to a load (such as an electrical machine). The charge manager 110 may distributes the load placed on the chargers by the power demand across the charge modules, according to the determined health status of the charge modules. By distributing and balancing the load across the charging modules, the system is able to increase the longevity of the power distribution sites by decreasing the wear and tear on each of the individual charging modules while maximizes power conversion efficiency or operating parameters. This reduces reduce cost, maximize productivity, and maximize efficiency of charging system.

What is claimed is:

1. A method comprising:
receiving, by a charge dispenser, a charge request from an electric machine, the charge request including a power demand;
receiving, by the charge dispenser, from a plurality of charging modules, one or more metrics corresponding to a charging module of the plurality of charging modules;
selecting, by the charge dispenser, a subset of the plurality of charging modules to satisfy the power demand, according to the one or more metrics; and
supplying, by the charge dispenser, power from the subset of charging modules to the electric machine, according to the power demand.

2. The method of claim 1, further comprising:
transmitting, by the charging dispenser, a request for the one or more metrics to each of the plurality of charging modules, the charging dispenser transmitting the request responsive to receiving the charge request.

3. The method of claim 1, further comprising:
selecting, by the charge dispenser, a first charging module of the plurality of charging modules as a primary charging module, according to one or more first metrics of the first charging module; and
selecting, by the charge dispenser, one or more second charging modules of the plurality of charging modules as secondary charging modules, according to one or more second metrics of the one or more second charging modules.

4. The method of claim 3, wherein the charge dispenser selects the first charging module as the primary charging module, according to at least one of a lifetime energy conversion total or a total number of operating hours of the first charging module being less than at least one of the lifetime energy conversion total or the total number of operating hours of the one or more second charging modules.

5. The method of claim 3, wherein the first charging module regulates an output voltage of the power supplied to the electric machine at a first output current, and wherein the one or second charging modules follow the output voltage and supply one or more second currents.

6. The method of claim 1, further comprising:
determining, by the charge dispenser, a number of the plurality of charging modules for supplying the power to the electric machine, according to the power demand.

7. The method of claim 6, wherein the charging dispenser determines the number of the plurality of charging modules to supply the power to the electric machine, according to an efficiency metric of the plurality of charging modules and the power demand.

8. The method of claim 1, further comprising:
determining, by the charge dispenser, a condition of each of the plurality of charging modules, according to the respective one or more metrics of the plurality of charging modules, the condition comprising one of a first condition or a second condition;
identifying, by the charge dispenser, a first subset of the plurality of charging modules having the first condition; and
determining, by the charge dispenser, whether power supplied from the first subset of the plurality of chargers satisfy the power demand of the charge request.

9. The method of claim 8, wherein, in response to the power supplied from the first subset satisfying the power demand, the charge dispenser selects the first subset of the power charging modules as the subset.

10. The method of claim 8, wherein, in response to the power supplied from the first subset not satisfying the power demand, the charge dispenser selects the first subset of the plurality of charging modules, and at least one charging module having the second condition, as the subset.

11. The method of claim 1, further comprising:
while supplying the power from the subset of charging modules,
receiving, by the charge dispenser, updated one or more metrics of the subset of charging modules;
selecting, by the charge dispenser, a different subset of the plurality of charge modules to supply power to the electric machine, according to the updated one or more metrics; and
supplying, by the charge dispenser, the power from the different subset of the plurality of charge modules to the electric machine.

12. The method of claim 1, wherein the one or more metrics comprise, for each charging module, at least one of a lifetime energy conversion total, a total number of operating hours, a coolant temperature, a derate status, or one or more efficiency curves.

13. The method of claim 1, wherein the subset of the plurality of charging modules comprises each of the plurality of charging modules.

14. The method of claim 1, further comprising determining, by the charge dispenser, that the power demand of the charge request is less than a maximum output power by each of the plurality of charging modules.

15. A charge dispenser comprising:
a charge connector configured to interface with one or more electric machines;
a communication interface communicably coupled to a plurality of charging modules; and
a processing circuit comprising one or more processors and memory storing instructions that, when executed, cause the processing circuit to:
receive a charge request from an electric machine which is interfacing with the charge connector, the charge request including a power demand;
receive, via the communication interface, from the plurality of charging modules, one or more metrics corresponding to a charging module of the plurality of charging modules;
select a subset of the plurality of charging modules to satisfy the power demand, according to the one or more metrics; and
supply, via the charge connector, power from the subset of charging modules to the electric machine, according to the power demand.

16. The charge dispenser of claim 15, wherein the processing circuit is configured to:
select, by the charge dispenser, a first charging module of the plurality of charging modules as a primary charging module, and one or more second charging modules of the plurality of charging modules as secondary charging modules, according to at least one of a lifetime energy conversion total or a total number of operating hours of the first charging module being less than at least one of the lifetime energy conversion total or the total number of operating hours of the one or more second charging modules,
wherein the first charging module regulates an output voltage of the power supplied to the electric machine at a first output current, and wherein the one or second charging modules follow the output voltage and supply one or more second currents.

17. The charge dispenser of claim 15, wherein the processing circuit is configured to:
determine a condition of each of the plurality of charging modules, according to the respective one or more metrics of the plurality of charging modules, the condition comprising one of a first condition or a second condition;
identify a first subset of the plurality of charging modules having the first condition; and
determine whether power supplied from the first subset of the plurality of chargers satisfy the power demand of the charge request.

18. The charge dispenser of claim 17, wherein,
in response to the power supplied from the first subset satisfying the power demand, the charge dispenser selects the first subset of the power charging modules as the subset, and
in response to the power supplied from the first subset not satisfying the power demand, the charge dispenser selects the first subset of the plurality of charging modules, and at least one charging module having the second condition, as the subset.

19. The charge dispenser of claim 15, wherein the one or more metrics comprise, for each charging module, at least one of a lifetime energy conversion total, a total number of operating hours, a coolant temperature, a derate status, or one or more efficiency curves.

20. A system, comprising:
a plurality of charging modules configured to receive power from a power source and supply output power; and
a charge dispenser comprising:
a charge connector configured to interface with one or more electric machines;
a communication interface communicably coupled to the plurality of charging modules; and
a processing circuit comprising one or more processors and memory storing instructions that, when executed, cause the processing circuit to:
receive a charge request from an electric machine which is interfacing with the charge connector, the charge request including a power demand;
receive, via the communication interface, from the plurality of charging modules, one or more metrics corresponding to a charging module of the plurality of charging modules;
select a subset of the plurality of charging modules to satisfy the power demand, according to the one or more metrics; and
supply, via the charge connector, power from the subset of charging modules to the electric machine, according to the power demand.
